(19) United States
(12) Patent Application Publication
(10) Pub. No.: US 2018/0115461 A1
(43) Pub. Date: Apr. 26, 2018

(54) SYSTEM AND METHOD FOR FACILITATING OPTIMIZATION AND ANALYTICS OF A MANAGED NETWORK

(71) Applicant: CENTRE FOR DEVELOPMENT OF TELEMATICS (C-DOT), Bangalore (IN)

(72) Inventors: VIPIN TYAGI, NEW DELHI (IN); SOUNDARAKUMAR MASILAMANI, BANGALORE (IN); BLUEMAX STEPHEN, BANGALORE (IN); CHARUMATI P, BANGALORE (IN); SULAKSHNA KULSHRESHTHA, BANGALORE (IN); G K REDDY CHINTHALAPUDI, BANGALORE (IN); ARIJIT PAUL, BANGALORE (IN)

(21) Appl. No.: 15/788,578

(22) Filed: Oct. 19, 2017

(30) Foreign Application Priority Data
Oct. 24, 2016 (IN) 201641036389

(51) Int. Cl. H04L 12/24; G06N 5/04; H04L 12/26

(52) U.S. Cl. CPC H04L 41/0823; H04L 43/045; H04L 41/22; G06N 5/04

(57) ABSTRACT

Disclosed herein is system and method for facilitating one of optimization or analytics of a managed network. The system collects data of different vendor specific formats from network components of different vendors and technologies comprised in the managed network. Then a user of the system selects one of a network optimization or analytics tools that are capable of processing the data through a user interface configured in the system. The selected optimization and analytics tools generate results comprising optimization recommendations and analytics data upon initialization. Finally, system receives the results from the optimization and analytics tools and implements the results on the network components, thereby optimizing the managed network. Hence, the system acts as a generic platform for facilitating optimization or analytics of the managed network, and allows a network administrator to optimize or analyze a managed network irrespective of the vendors, technologies and domains to which the components belong.

### TECHNICAL FIELD

The present subject matter is related, in general to network management, and more particularly, but not exclusively to a system and method for facilitating optimization and analytics of a managed network.

### BACKGROUND

System optimization and analytics are performed to enhance the execution of the system with existing assets. By performing optimization and analytics of a certain system, one tries to better use the existing system assets, take care of existing and potential issues in the system. Through optimization and analytics, the administration quality and assets utilization of the system are incredibly enhanced to accomplish a harmony between scope, limit and quality.

In an ordinary optimization platform, the network asset utilization enhancement is accomplished manually by specialists. The manual procedure is tedious and is prone to a lot of errors. Moreover, the manual tuning process increases overall cost of the system maintenance, resulting in an increase in Operational Expenditure (OPEX) of a system administrator. With overgrowing network, changes in the topologies and working conditions, it is becoming difficult for the system administrator to maintain a cost-effective, efficient network system.

The current era of new and developing technologies are cultivating unstable development of remote information utilization by open networks. Accordingly, service providers need to have high speed efficient applications and administrations on their systems. On the system side, the networks are turning out to be more heterogeneous and the system administrator requires all control data at a specific centralized place to analyze the network and predict future severity problems.

Further, the system administrators cannot oversee development of a network system physically any longer. The system administrator needs to run a great deal of improvement calculations to do the system enhancement. Also, optimizations are performed for a specific problem in a specific domain which are not much reusable by others or not compatible for other solutions/vendors. Hence, a generic platform, which hides any vendor-specific dependency from the user and/or the system administrator is required for domain/vendor specific issues of the network. Such a general purpose platform for optimization and analytics of the network may reduce planning, configuration and optimization efforts for a system administrator, thereby reducing manual involvement in such tasks.

The challenges mainly faced in performing optimization and analytics of a managed network includes providing a generic platform for facilitating optimization and analytics of different network components of different vendors and different technologies that are comprised in the managed network.

### SUMMARY

Disclosed herein is a system to facilitate at least one of optimization or analytics of a managed network, the managed network comprising one or more network components of different vendors and different technologies. The system comprises a processor and a memory. The memory is communicatively coupled to the processor, wherein the memory stores processor-executable instructions, which, on execution, causes the processor to collect data from one or more network components through a data communication network, wherein the data is of different vendor specific formats. Further, the system receives selection of at least one of network optimization or analytics tools from a list of plurality of network optimization or analytics tools capable of processing the data of at least one specific format of the different vendor specific formats. Furthermore, the system initializes the at least one of the network optimization or analytics tools being selected for facilitating at least one of optimization or analytics on the data, wherein the at least one of the network optimization or analytics tools generate one or more results comprising at least one of analytics data for analytics of the one or more network components or recommendations for optimization of the one or more network components, upon initialization.

Further, the present disclosure presents a method for facilitating at least one of optimization or analytics of a managed network, the managed network comprising one or more network components of different vendors and different technologies. The method comprises the steps of collecting, by a system, data from one or more network components through a data communication network, wherein the data is of different vendor specific formats. Further, a selection on at least one of network optimization or analytics tools from a list of plurality of network optimization or analytics tools capable of processing the data of at least one specific format of the different vendor specific formats is received. Furthermore, the at least one of the network optimization or analytics tools being selected are initialized for facilitating at least one of optimization or analytics on the data. The at least one of the network optimization or analytics tools generate one or more results comprising at least one of analytics data for analytics of the one or more network components or recommendations for optimization of the one or more network components, upon initialization.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment for facilitating at least one of optimization or analytics of a managed network in accordance with some embodiments of the present disclosure;

FIG. 2 shows a detailed block diagram illustrating a system in accordance with some embodiments of the present disclosure;

FIG. 3 illustrates an exemplary use case scenario of the system in accordance with some embodiments of the present disclosure;

FIG. 4 shows a flowchart illustrating a method for facilitating at least one of optimization or analytics of a managed network in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a system for facilitating at least one of optimization of analytics of a managed network. As an example, the managed network may be any type of network but not limited to, a local area network, a wide area network, a core network, a radio access network, a Machine-to-Machine (M2M) network, an Internet of Things (IoT) network, a backbone transmission network or a combination thereof. The system may be connected to one or more managed networks on which optimization and/or analytics has to be performed. In an embodiment, a user of the system, with the help of a User Interface (UI) configured in the system, selects one or more managed nodes and/or one or more network components of different vendors of different technologies of different domains that have to be optimized or analyzed. As an example, the one or more network components to be optimized and/or analyzed may include, but not limited to, an end node in the managed network, a middle managed node, or a higher managed node, or a combination thereof. As an example, the one or more domains to which the one or more network components may belong includes, without limiting to, wireless communication, wired communication, M2M communication, IoT network or IP network. As an example, the one or more technologies to which the one or more network components belong may include, but not limited to, Global System for Mobile Communications (GSM), Universal Mobile Telecommunications System (UMTS), a Long-term Evolution (LTE), Code division multiple access (CDMA) etc. in wireless domain, or Asynchronous Transfer Mode (ATM), Ethernet etc. in IP domain, and smart electricity metering, traffic optimization in M2M/IoT domain.

Further, the user uses the UI to select and interface one or more optimization tools and/or one or more analytics tools on the system. Then, the user maps the one or more selected network components of different vendors of different technologies with the one or more optimization tools or analytics tools interfaced in the system.

In an implementation, a Data Mediation Interface Manager (DMIM) module configured in the system mediates with the one or more network components of different vendors of different technologies and helps in collection of data from the selected one or more network components. Similarly, an Application Mediation Interface Manager (AMIM) module configured in the system mediates with the one or more optimization tools and analytics tools and helps in interfacing the one or more optimization tools and analytics tools on the system. In an embodiment, the system may store all the data collected from each of the one or more network components for facilitating optimization and/or analytics of the one or more components.

In an embodiment, the system maintains coordination among the one or more optimization tools and/or analytics tools to be executed for facilitating the optimization and/or analytics of the one or more network components, so that any conflicts that may arise during initialization of the tools may be avoided in order to improve the overall network performance. The one or more optimization tools and/or analytics tools generate one or more results comprising at least one of analytics data for analytics of the one or more network components or recommendations for optimization of the one or more network components upon initialization. Further, the system creates one or more network management tasks to implement the one or more results comprising the recommendations on the one or more network components. The one or more network management tasks are then scheduled for execution at a predetermined time of execution. A context of execution of each of the one or more optimization tools or analytics tools to be executed on the one or more network components are stored in the system during execution of the one or more optimization tools and/or analytics tools.

In an embodiment, the one or more optimization tools may include, but not limiting to, a third party optimization system, tool or an optimization algorithm. Similarly, the one or more analytics tools may include, without limiting to, a third party analytics system, product or an analytic algorithm. In an implementation, the one or more optimization tools and analytics tools may include, without limiting to, a third party simulator like MATLAB, NS-3 etc.

In an embodiment, the system disclosed in the present disclosure enables a stakeholder/system administrator of a managed network to create a data hub that acts as a centralized place where all managed network data and optimized network data can be processed at a single place. Also, the system may substantially reduce efforts of a network administrator by automatically performing repetitive activities as per the configuration provided by the system user or administrator. Also, the instant method helps in building a centralized system and writing IoT/M2M use cases such as smart home automation, smart office automation, smart electricity metering, smart water metering, traffic optimization etc. The disclosed method also helps in building centralized SON solutions for LTE, UMTS, GSM etc.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

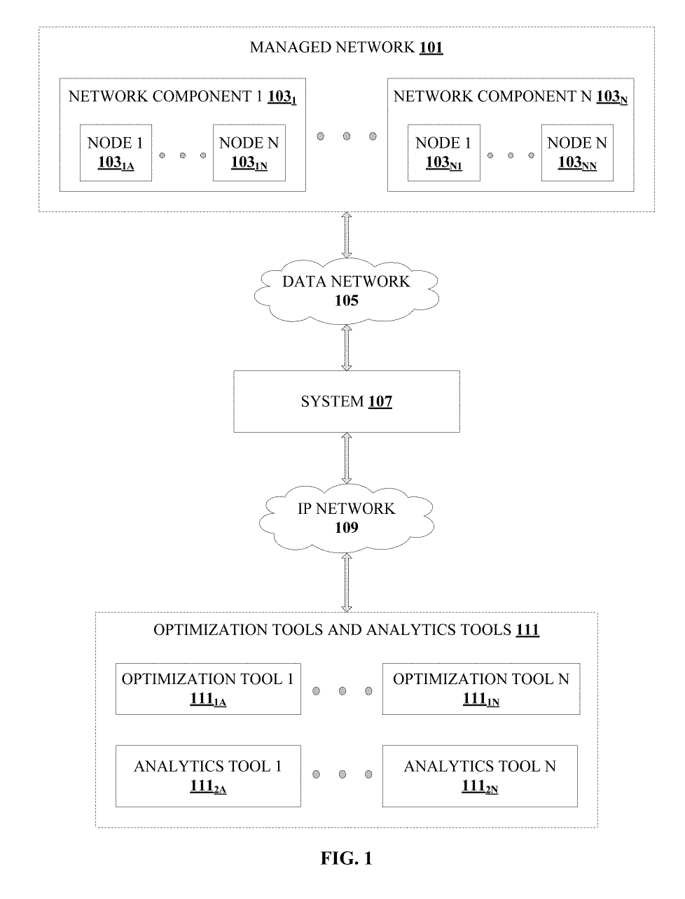

FIG. 1 shows an exemplary environment for facilitating at least one of optimization or analytics of a managed network in accordance with some embodiments of the present disclosure.

The environment comprises a system 107 for facilitating monitoring and optimization of one or more network components of different vendors of different technologies comprised in a managed network 101 with the help of one or more optimization tools and analytics tools 111. The managed network 101 may consist of multiple network components, network component 1 103₁ to network component N 103_{N} (collectively referred to as network component 103), and a single network component 103 may consist of multiple management nodes and managed nodes. The managed network 101 may be any type of network, a local area network, a wide area network, core network, backbone transmission network or a combination thereof. In another example, the managed network 101 may be formed by different types of devices or same type of devices implemented with different versions of software/hardware/firmware to provide their respective services. As an example, the network component 103 may be a Network Element (NE), a Network Management System (NMS) or an Element Management System (EMS) of multiple technologies belonging to different or same vendor.

The system 107 may be a generic framework/platform for writing applications that facilitate in optimization and/or analytics of data collected from the one or more network components 103. The system 107 may provide mediation for any kind of data received from the managed network 101. The data may be sent to the one or more optimization tools and analytics tools 111 for receiving the one or more optimization recommendations 213 and/or analytics data 215 (not shown in FIG. 1). Further, the system 107 may apply the one or more optimization recommendations 213 back to the managed network 101. In one embodiment, all the functionalities of the system 107 may operate in a centralized and/or in a distributed mode over one or more computing systems including, without limiting to, a desktop class system, a workstation, a server or a combination thereof or a cloud computing platform as well.

In an implementation the system 107 may communicate with each of the one or more network components 103 in the managed network 101 using a data network 105. The data network 105, in one embodiment, may be a network that enables the system 107 to reach the managed network 101. In another embodiment the data network 105 may be a managed network 101 itself or a combination of one or more separate managed networks 101. Further, the system 107 may communicate with the one or more optimization tools and analytics tools 111 using an IP network 109. The one or more optimization tools and analytics tools 111 may be third party/off-the-shelf optimization tools and techniques which are independent of the system 107. The one or more optimization tools and analytics tools 111 may be a combination of the one or more optimization tools, optimization tool 1 111_{1A} to optimization tool N 111_{1N} (collectively referred to as optimization tools 111₁) or the one or more analytics tools analytics tool 1 111_{2A} to analytics tool N 111_{2N} (collectively referred to as analytics tools 111₂). Here, each of the one or more optimization tools 111₁ may be capable of performing different optimization functionalities.

In an implementation, the one or more optimization tools and analytics tools 111, which are located in an external environment, may interface with the system 107 through standard APIs. The interface between the system 107 and the one or more optimization tools and analytics tools 111 may be an Internet Protocol (IP) network 109. In another implementation, the one or more optimization tools 111₁, analytics tools 111₂ and the system 107 may be run on a same platform, without requiring an IP network 109 for interfacing the one or more optimization tools and analytics tools 111 with the system 107.

In an embodiment, the system 107 may collect data from the one or more network components 103 over the data network 105. The data collected by the system 107 are provided to the one or more optimization tools and analytics tools 111 through the IP network 109. Further, the one or more optimization tools and analytics tools 111 use the data received by the system 107 and generate results comprising one or more optimization recommendations 213 and/or analytics data 215 by applying the one or more optimization methods and/or analytics methods on the received data.

Then the system 107 may communicate the optimization recommendations 213 and/or analytics data 215 generated by the one or more optimization tools and analytics tools 111 to the one or more network components 103 of the managed network 101. In an embodiment, the system 107 may communicate the one or more optimization recommendations 213 and/or analytics data 215 with one or more other optimization tools 111₁ and/or analytics tools 111₂ for further optimization and analytics of the generated optimization recommendations 213.

Here, a system administrator associated with the managed network 101 may utilize the underlined generic framework (the system 107) to achieve a fast and better optimization of the managed network 101. The instant description relates to the method and the system 107 which facilitates exchange of analytics data 215 and/or optimization recommendation 213 between the one or more network components 103 and the one or more optimization tools and analytic tools 111. The above method is being achieved using the disclosed framework by absorbing all the mediation complexities related to the one or more network components 103 from more than one vendors in multiple technologies. The framework, is thus capable of optimizing and analysing the one or more managed networks 101 and/or the one or more network components 103 within the same managed network 101 that are implemented in multiple interface languages.

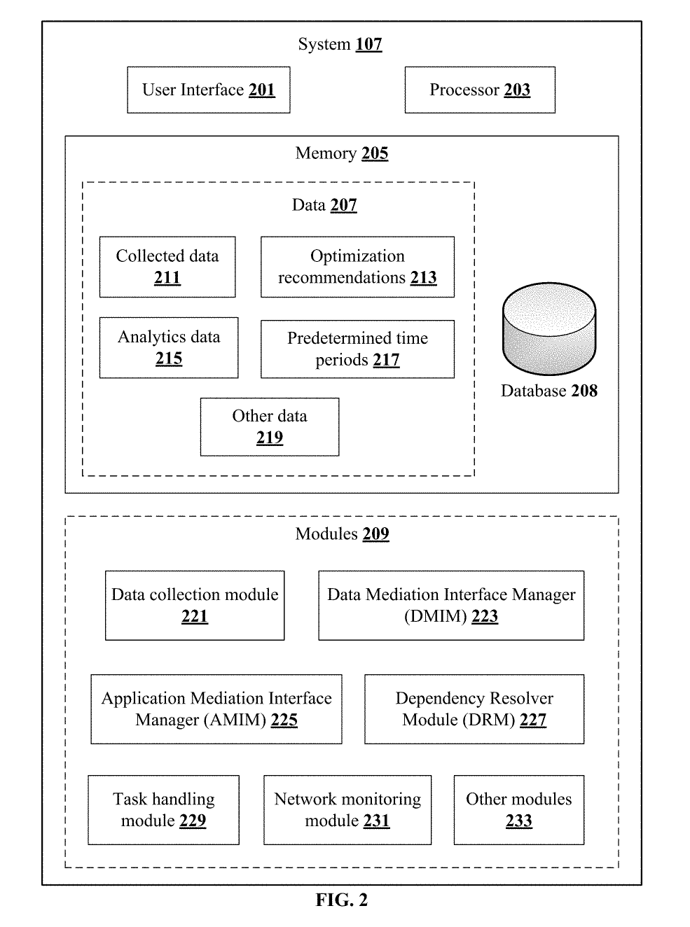

FIG. 2 shows a detailed block diagram illustrating a system in accordance with some embodiments of the present disclosure.

The system 107 comprises a User Interface (UI) 201, a processor 203 and a memory 205. The UI 201 configured in the system 107 may facilitate a user of the system 107 to select and configure the one or more optimization tools and analytics tools 111 on to the system 107. Also, the UI 201 may facilitate the user to include different vendors for the one or more network components 103 of different technologies. Further, the UI 201 may facilitate the user for identifying the one or more network components 103 to be optimized and/or analysed using the one or more optimization tools and analytics tools 111. Finally, each of the one or more optimization recommendations 213 and analytics data 215 generated by the one or more network optimization tools 111₁ and/or analytics tools 111₂ are displayed to the user on the UI 201.

The memory 205 is communicatively coupled to the processor 203. The processor 203 is configured to perform one or more functions of the system 107 for facilitating at least one of optimization and analytics of the managed network 101. In one implementation, the system 107 comprises data 207 and modules 209 for performing various operations in accordance with the embodiments of the present disclosure. In an embodiment, the data 207 may be stored within the memory 205 and may include, without limiting to, collected data 211, optimization recommendations 213, analytics data 215, predetermined time periods 217 and other data 219 and a Database (DB) 208.

In one embodiment, the data 207 may be stored within the memory 205 in the form of various data structures. Additionally, the aforementioned data 207 can be organized using data models, such as relational or hierarchical data models. The other data 219 may store data, including temporary data and temporary files, generated by modules 209 for performing various functions of the system 107.

In an embodiment, the collected data 211 are the data collected by the system 107 about the one or more network components 103 in the managed network 101. As an example, the collected data 211 may include, without limiting to, one or more performance related information of the one or more network components 103, status information of the one or more network components 103 etc. The collected data 211 are taken as an input by the one or more optimization tools and analytics tools 111 and are used for generating the one or more optimization recommendations 213 and analytics data 215.

In an embodiment, the optimization recommendations 213 are generated by the one or more optimization tools 111₁ based on the collected data 211. The optimization tools 111₁, upon receiving the collected data 211, execute/apply one or more optimization methods on the collected data 211 in order to generate one or more optimization recommendations 213 corresponding to the collected data 211. Subsequently, the system 107 may communicate and implement the one or more optimization recommendations 213 on the one or more network components 103, thereby facilitating in optimization of the managed network 101. In an implementation, the one or more optimization recommendations 213 are displayed on the UI 201 to facilitate the user to view and select the one or more optimization recommendations 213 to be implemented on the one or more network components 103.

In an embodiment, the analytics data 215 are the data generated by the one or more analytics tools upon performing analytics of the collected data 211. As an example, the analytics data 215 may be in the form of graphs, flowcharts etc., based on the configuration of the analytics tools being used for performing analytics. The analytics data 215 may be used for analyzing the one or more components in the managed network 101, thereby identifying one or more potential variations and failures in the managed network 101, if any. In an implementation, the analytics data 215 may also be displayed on the UI 201 for facilitating the user to view and understand the analytics data 215.

In an embodiment, the predetermined time periods 217 are various pre-set time slots including a predetermined observation time, a predefined restoration time period and a predetermined time of execution. The predetermined observation time is the total time for which the one or more network components 103 are monitored upon implementing the one or more optimization recommendations 213 on the one or more network components 103. The predefined restoration time period is the time for which consistency of the managed network 101 is monitored upon applying the one or more optimization recommendations 213. Further, the predetermined time of execution are the one or more time slots in which the system 107 schedules execution of each of the one or more network management tasks. The one or more time slots may be based on periodic execution as configured by the user from UI 201 or a trigger from the managed network 101.

In an embodiment, the data 207 may be processed by one or more modules 209 of the system 107. In one implementation, the one or more modules 209 may be stored as a part of the processor 203. In another implementation, the one or more modules 209 may be communicatively coupled to the processor 203 for performing one or more functions of the system 107. The modules 209 may include, without limiting to, a data collection module 221, a Data Mediation Interface Manager (DMIM) module 223, an Application Mediation Interface Manager (AMIM) module 225, a Dependency Resolver Module (DRM) 227, a task handling module 229, a network monitoring module 231 and other modules 233.

As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 233 may be used to perform various miscellaneous functionalities of the system 107. It will be appreciated that such aforementioned modules 209 may be represented as a single module or a combination of different modules.

In an embodiment, the data collection module 221 may be responsible for collecting data from the one or more network components 103 through the Data network 105. The collected data 211 may be in different vendor specific formats based on the vendor of the one or more network components 103 to which the collected data 211 relates to.

In an embodiment, the DMIM module 223 may be responsible for processing all the data collected from the one or more network components 103, the data comprising requests and notifications from the one or more network components 103. The DMIM module 223 may also be responsible for applying the one or more optimization recommendations 213 back to the one or more network components 103, wherein the data format of the one or more optimization recommendations 213 may be specific to each of the one or more network component 103. In an embodiment, the DMIM module 223 may be communicatively connected to a database (DB) 208 in the system 107 for storing the collected data 211 and the one or more optimization recommendations 213. In one implementation, the DMIM module 223 may be configured with different vendor specific data formats to enable the DMIM module 223 to effectively mediate with the one or more network components 103 irrespective of the vendor specific data formats and development/interface language being used in the one or more network components 103.

The AMIM module 225 mediates between the system 107 and the one or more optimization methods and analytics methods. The AMIM module 225 may be communicatively connected to the DB 208 in the system 107 and may be configured to interact with the DB 208 for writing the optimized data onto the DB 208. The AMIM module 225 may be configured with all details specific to the one or more optimization tools and analytics tools 111 and therefore the AMIM module 225 is capable of mediating one or more types of optimization recommendations 213 and analytics data 215 irrespective of the development/interface language of the one or more optimization tools and analytics tools 111 being used for facilitating the optimization and/or analytics of the managed network 101.

In an embodiment, the UI 201 configured in the system 107 may be communicatively connected with the DB 208 and facilitates the user to view, write and access the collected data 211 and the optimized data stored in the DB 208. The UI 201 may be further configured to display optimization specific information in a user friendly and readable format from the DB 208 for facilitating the users in identifying the one or more optimization recommendations 213 and analytics data 215.

In an embodiment, the DRM module 227 may be responsible for monitoring and managing dependencies among the one or more optimization tools and analytic tools 111 being used for facilitating the optimization and/or analytics of the managed network 101. The DRM module 227 establishes coordination between the network optimization or analytics tools to eliminate conflicts during initialization of the network optimization tools and analytics tools 111 in the system 107. In case if there are any conflict dependencies among the one or more optimization tools and analytic tools 111, then the DRM module 227 resolves those conflicts before scheduling the one or more optimization tools and analytic tools 111 for execution, thereby avoiding any potential conflicts in the one or more network components 103 subsequent to optimization.

In an embodiment, the task handling module 229 may be responsible for creating one or more network management tasks to implement the one or more results comprising the optimization recommendations 213 on the one or more network components 103. Also, the task handling module 229 schedules the execution of each of the one or more network management tasks at predetermined time of execution. In an implementation, the one or more network management tasks may be executed at one or more predetermined time intervals or upon receiving a user input. As an example, the user may provide an explicit trigger to start the execution of the one or more network management tasks using the UI 201. Further, the task handling module 229 is responsible for scheduling and monitoring one or more network management tasks including, without limiting to, monitoring each instance of execution of the one or more management tasks and maintaining sanity of the execution.

In an implementation, the task handling module 229 handles execution of a single task at a time and when there are simultaneous multiple instances of executions, the parallel execution of all the multiple instance are managed as scheduled tasks. Further, upon completion of execution of all the instances, status of each of the one or more network management tasks are updated and stored in the DB 208.

In an embodiment, the network monitoring module 231 may be responsible for monitoring the one or more network components 103 for a predetermined observation time period upon applying the optimization recommendations 213. The network monitoring module 231 may also be responsible for monitoring the consistency of the network for a predefined restoration time period upon applying the optimization recommendations 213.

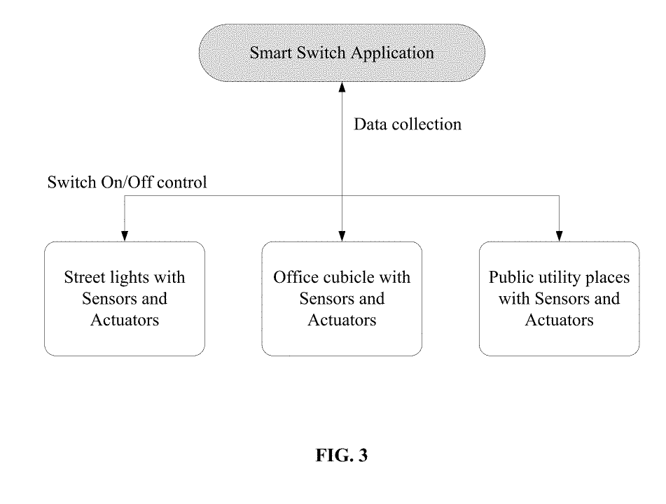

FIG. 3 illustrates an exemplary use case scenario in which the system 107 may be used in accordance with some embodiments of the present disclosure.

### Use Case 1—Smart Switch Application:

FIG. 3 represents a Smart Switch Application for controlling operations of one or more components, such as street lights, lighting components in an office cubicle and other components disposed at public utility places. The system 107 disclosed in the instant disclosure may be used by the Smart Switch Application for performing at least one of optimization and/or analytics of the one or more components, listed above, which are of different types and belong to different network/network technologies. In embodiment, the Smart Switch Application may be configured at a centralized location. The Smart Switch Application may collect different operational data from each of the one or more components and communicates the collected operational data to the one or more network optimization tools and analytics tools 111 for optimizing and/or analysing the one or more components. In an implementation, the one or more optimization tools and analytics tools 111 may be configured on the same system/machine in which the Smart Switch Application is configured. In an alternative implementation, the one or more optimized tools and analytics tools may be configured on an external computing system and then disposed in communication with the Smart Switch Application.

As an example, the Smart Switch Application may collect information related to “Switch ON” and “Switch OFF” timings of the street lights, along with values of intensity of light in the surroundings of the street light with the help of sensors and actuators. Later, the collected information may be transmitted to the one or more optimization tools and analytics tools 111 for generating optimization recommendations 213 or analytics data 215 corresponding to the collected information. For example, one of the optimization recommendation may be to delay the “Switch ON” timing of the street light when the intensity of light in the surroundings of the street light is higher than a threshold light intensity value. Thus, by implementing such an optimization recommendation on to the street lights helps in avoiding unnecessary wastage of energy.

Similarly, in an Office cubicle, one or more sensors may be installed at one or more locations in the cubicle to monitor and detect presence of an employee in the cubicle. Further, the one or more sensors may be configured to transmit the monitored data in real-time to the Smart Switch Application which uses the system 107. The Smart Switch Application, using the one or more optimization tools and analytics tools interfaced with the system 107, analyses the data received from the sensors and generates one or more optimization recommendations. Finally, the Smart Switch Application implements the one or more optimization recommendations in the cubicle using one or more actuators that are interfaced with one or more components in the cubicle. As an example, one of the optimization recommendation generated by the Smart Switch Application may be is to turn off the lights and other electronic components in the Office cubicle when there is no one present in the Office cubicle. Here, even though the sensors, the actuators, the communication channel and the one or more components to be controlled in the Office cubicle may be manufactured by different vendors, the Smart Switch Application makes it possible for a user to control each component in the cubicle using a generic, centralized platform/application.

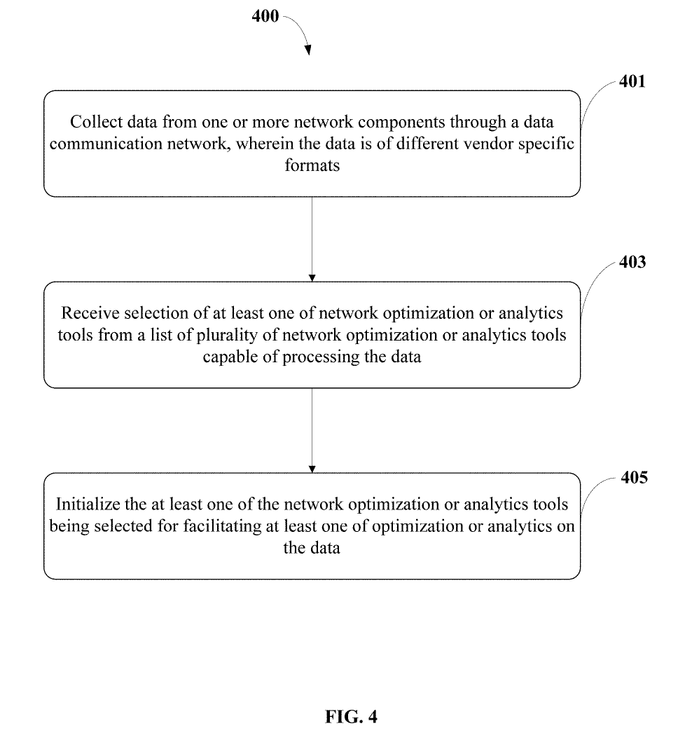

FIG. 4 shows a flowchart illustrating a method for facilitating at least one of optimization or analytics of a managed network in accordance with some embodiments of the present disclosure.

As illustrated in FIG. 4, the method 400 comprises one or more blocks to facilitate at least one of optimization or analytics of a managed network 101 using a system 107. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the system 107 may collect data from one or more network components 103 through a data communication network, wherein the data is of different vendor specific formats. The managed network 101 comprises one or more network components 103 of different vendors and different technologies.

At block 403, the system 107 may receive selection of at least one of network optimization or analytics tools from a list of plurality of network optimization or analytics tools capable of processing the data of at least one specific format of the different vendor specific formats.

At block 405, the system 107 may initialize the at least one of the network optimization or analytics tools being selected for facilitating at least one of optimization or analytics of the data. The at least one of the network optimization or analytics tools generate one or more results comprising at least one of analytics data 215 for analytics of the one or more network components 103 or recommendations 213 for optimization of the one or more network components 103, upon initialization.

In an embodiment, initializing the at least one of the network optimization or analytics tools on the system comprises interfacing the system with at least one of the network optimization or analytics tools. Further, the at least one of the network optimization or analytics tools are initialized at one or more predetermined time intervals or upon receiving a user input.

In an embodiment, the system 107 comprises a User Interface (UI) 201 to facilitate a user of the system 107 to configure the network optimization or analytics tools in the system 107 and to facilitate the user to include different vendors for the one or more network components 103 of different technologies. The UI 201 also facilitates the user to identify the one or more network components 103 for at least one of the optimization or analytics. Further, the UI 201 displays the one or more results to the user.

In an embodiment, the one or more network components 103 are monitored for a predetermined observation time period upon applying the recommendations 213. The consistency of the network is monitored for a predefined restoration time period upon applying the optimization recommendations 213. Further, the system 107 establishes coordination between the network optimization or analytics tools to eliminate conflicts during initialization of the network optimization or analytics tools. Finally, the one or more results comprising the optimization recommendations 213 are implemented on the one or more network components 103 by creating one or more network management tasks to implement the one or more results comprising the optimization recommendations 213 on the one or more network components 103. In an implementation, the system 107 schedules execution of each of the one or more network management tasks at predetermined time of execution, thereby optimizing the managed network 101.

### Computer System

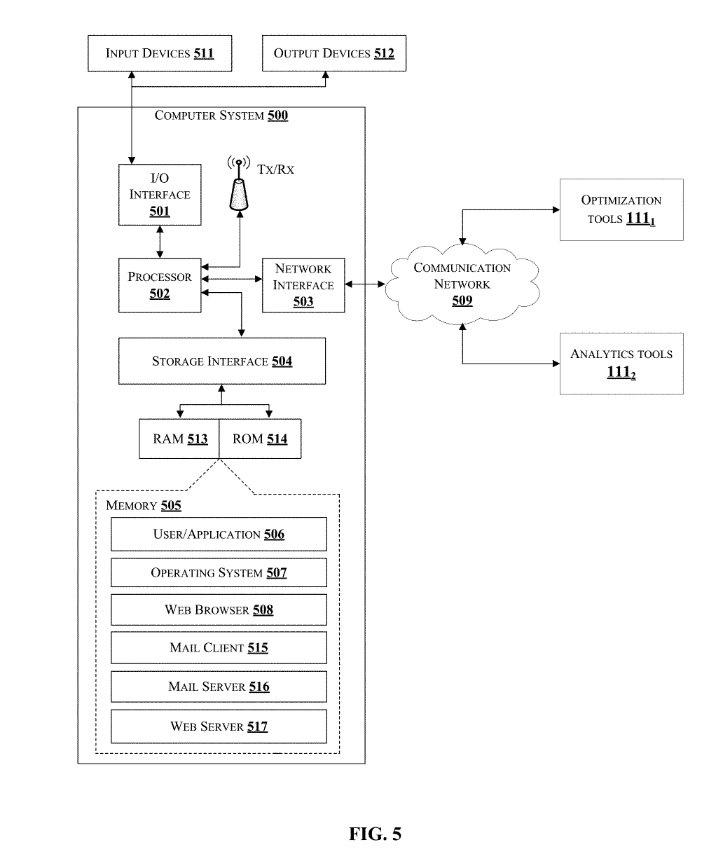

FIG. 5 illustrates a block diagram of an exemplary computer system 500 for implementing embodiments consistent with the present invention. In an embodiment, the computer system 500 can be the system 107 which facilitates in at least one of optimization or analytics of a managed network 101. The computer system 500 may comprise a central processing unit (“CPU” or “processor”) 502. The processor 502 may comprise at least one data processor for executing program components for executing user- or system-generated business processes. A user may include a person, a person using a device such as those included in this invention, or such a device itself. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System for Mobile communications (GSM), Long-Term Evolution (LTE) or the like), etc.

Using the I/O interface 501, the computer system 500 may communicate with one or more I/O devices (511 and 512).

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 503 and the communication network 509, the computer system 500 may communicate with one or more optimization tools 111₁ or analytics tools 111₂. The communication network 509 can be implemented as one of the different types of networks, such as intranet or Local Area Network (LAN) and such within the organization. The communication network 509 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application data 506, an operating system 507, web server 508 etc. In some embodiments, computer system 500 may store user/application data 506, such as the data, variables, records, etc. as described in this invention. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. A user interface may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 500 may implement a web browser 508 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 500 may implement a mail server 516 stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client 515 stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the present disclosure provides a method for facilitating optimization and analytics of one or more network components of different vendors and different technologies using one or more different optimization and analytics tools.

In an embodiment, the present disclosure provides a generic network management platform which facilitates optimization and analytics of one or more network components of different vendors and technologies, thereby providing a technology independent and multi-vendor compatible network optimization or analytics.

In an embodiment, the generic platform disclosed in the present disclosure can simultaneously facilitate optimization and analytics of multiple network components and can be made scalable to optimize a managed network of any size.

In an embodiment, the method of present disclosure simplifies the process of managing a management by allowing a trigger based execution of the one or more optimization tools on the network.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERENCE NUMERALS

| Reference | |
|---|---|
| Number | Description |
| 101 | Managed network |
| 103 | Network component |
| 105 | Data Network |
| 107 | System |
| 109 | IP Network |
| 111 | Optimization tools and analytics tools |
| 111₁ | Optimization tools |
| 111₂ | Analytics tools |
| 201 | User interface (UI) |
| 203 | Processor |
| 205 | Memory |
| 207 | Data |
| 208 | Database |
| 209 | Modules |
| 211 | Collected data |
| 213 | Optimization recommendations |
| 215 | Analytics data |
| 217 | Predetermined time periods |
| 219 | Other data |
| 221 | Data collection module |
| 223 | Data Mediation Interface Manager (DMIM) |
| 225 | Application Mediation Interface Manager |
| | (AMIM) |
| 227 | Dependency Resolver Module (DRM) |
| 229 | Task handling module |
| 231 | Network monitoring module |
| 233 | Other modules |

1. A system to facilitate at least one of optimization or analytics of a managed network, the managed network comprising one or more network components of different vendors and different technologies, the system comprising:
a processor; and
a memory communicatively coupled to the processor, wherein the memory stores processor-executable instructions, which, on execution, causes the processor to:
collect data from one or more network components through a data communication network, wherein the data is of different vendor specific formats;
receive selection of at least one of network optimization tools or analytics tools from a list of plurality of network optimization tools or analytics tools capable of processing the data of at least one specific format of the different vendor specific formats; and
initialize the at least one of the network optimization tools or analytics tools being selected for facilitating at least one of optimization or analytics on the data, wherein the at least one of the network optimization tools or analytics tools generate one or more results comprising at least one of analytics data for analytics of the one or more network components or recommendations for optimization of the one or more network components, upon initialization.

2. The system as claimed in claim 1 further comprises a User Interface (UI) to:
facilitate a user of the system to configure the network optimization tool or analytics tools in the system;
facilitate the user to include different vendors for the one or more network components of different technologies;
facilitate the user to identify the one or more network components for at least one of the optimization or analytics; and
display the one or more results to the user.

3. The system as claimed in claim 1, wherein the initializing the at least one of the network optimization tools or analytics tools on the system comprises interfacing the system with at least one of the network optimization tools or analytics tools.

4. The system as claimed in claim 3, wherein the at least one of the network optimization tools or analytics tools are initialized at one or more predetermined time intervals or upon receiving a user input.

5. The system as claimed in claim 1, wherein the one or more network components are monitored for a predetermined observation time period upon applying the recommendations.

6. The system as claimed in claim 1, wherein consistency of the network is monitored for a predefined restoration time period upon applying the recommendations.

7. The system as claimed in claim 1, wherein the processor establishes coordination between the network optimization tools or analytics tools to eliminate conflicts during initialization of the network optimization tools or analytics tools.

8. The system as claimed in claim 1, wherein the instructions further cause the processor to implement the one or more results comprising the recommendations on the one or more network components, thereby optimizing the managed network.

9. The system as claimed in claim 8, wherein the processor creates one or more network management tasks to implement the one or more results comprising the recommendations on the one or more network components.

10. The system as claimed in claim 9, wherein the processor schedules execution of each of the one or more network management tasks at predetermined time of execution.

11. A method for facilitating at least one of optimization or analytics of a managed network, the managed network comprising one or more network components of different vendors and different technologies, the method comprises:
collecting, by a system, data from one or more network components through a data communication network, wherein the data is of different vendor specific formats;
receiving, by the system, selection of at least one of network optimization tools or analytics tools from a list of plurality of network optimization tools or analytics tools capable of processing the data of at least one specific format of the different vendor specific formats; and
initializing, by the system, the at least one of the network optimization tools or analytics tools being selected for facilitating at least one of optimization or analytics on the data, wherein the at least one of the network optimization tools or analytics tools generate one or more results comprising at least one of analytics data for analytics of the one or more network components or recommendations for optimization of the one or more network components, upon initialization.

12. The method as claimed in claim 11, further comprises:
facilitating, through a User Interface (UI) associated with the system, a user of the system to configure the network optimization tools or analytics tools in the system;
facilitating the user for including different vendors for the one or more network components of different technologies;
facilitating the user for identifying the one or more network components for at least one of the optimization or analytics; and
displaying, on the UI, the one or more results to the user.

13. The method as claimed in claim 11, wherein the initializing the at least one of the network optimization tools or analytics tools on the system comprises interfacing the system with at least one of the network optimization tools or analytics tools.

14. The method as claimed in claim 13, wherein the initialization of the at least one of the network optimization tools or analytics tools is performed at one or more predetermined time intervals or upon receiving a user input.

15. The method as claimed in claim 11 further comprises monitoring the one or more network components for a predetermined observation time period upon applying the recommendations.

16. The method as claimed in claim 11 further comprises monitoring consistency of the network for a predefined restoration time period upon applying the recommendations.

17. The method as claimed in claim 11, further comprises establishing coordination between the network optimization tools or analytics tools for eliminating conflicts during initialization of the network optimization tools or analytics tools.

18. The method as claimed in claim 11 further comprises implementing the one or more results comprising the recommendations on the one or more network components, thereby optimizing the managed network.

19. The method as claimed in claim 18, wherein one or more network management tasks are created for implementing the one or more results comprising the recommendations on the one or more network components.

20. The method as claimed in claim 19, wherein execution of each of the one or more network management tasks is scheduled at predetermined time of execution.
